(19) United States
(12) Patent Application Publication
(10) Pub. No.: US 2013/0049357 A1
(43) Pub. Date: Feb. 28, 2013

(54) SWIVEL DEVICE

(71) Applicants: Joakim Harr, Vindeln (SE); Olof Fridolfsson, Raa (SE); Niclas Karlsson, Umea (SE)

(72) Inventors: Joakim Harr, Vindeln (SE); Olof Fridolfsson, Raa (SE); Niclas Karlsson, Umea (SE)

(21) Appl. No.: 13/261,440

(22) PCT Filed: Mar. 25, 2011
(86) PCT No.: PCT/SE11/00055

§ 371 Date: Sep. 24, 2012

(30) Foreign Application Priority Data
Mar. 26, 2010 (SE) SE1000293-9

(51) Int. Cl. F16L 27/08

(52) U.S. Cl. 285/184

(57) ABSTRACT

The invention relates to a swivel device, in particular designed to connect two pipes or hoses rotating relative to one another, wherein the device (10) includes a first centre part (20) provided with a hole and comprising a fastening portion (22) for the attachment of a first pipe, the device (10) includes a second centre part (30) provided with a hole and comprising a fastening portion (32) for the attachment of a second pipe, the first centre part (20) and the second centre part (30) being rotatable relative to one another. The centre parts (20, 30) are held together by means of an outer sleeve (150) anchored at one end to the second centre part (30) and at its other end arranged in a rotationally slidable manner relative to the first centre part (20). A first axial sliding bearing (140) is arranged between the outer sleeve (150) and the first centre part (20) and a second axial sliding bearing (190) is arranged between the first centre part (20) and the second centre part (30). The first centre part (20) is axially displaceable between a first position in which the first axial sliding bearing (140) is operative and a second position in which the second axial sliding bearing (190) is operative.

### TECHNICAL FIELD

This invention relates to a swivel device according to the pre-characterising part of claim 1.

### BACKGROUND OF THE INVENTION

So-called swivels or swivel devices are used when a medium, e.g. hydraulic oil, is to be transferred between two pipes/tubes/hoses rotating relative to one another.

### AIM OF THE INVENTION

The aim of this invention is to provide an extremely advantageous swivel device. This aim is achieved in that the device has the features specified in the claims.

### ADVANTAGES OF THE INVENTION

The advantages of the invention include the following.

The swivel device is rotated very easily as a result of the fact that axial loading of the device is reduced, eliminated or adapted to the current operating conditions.

Integral bearings result in dimensioning advantages. The invention offers both technical and economic advantages.

### BRIEF DESCRIPTION OF THE DRAWINGS

Embodiments of the invention will now be described with reference to the accompanying drawing.

FIG. 1 is a longitudinal section through a swivel device according to the invention.

FIG. 2 is a perspective view of the swivel device according to FIG. 1.

### DETAILED DESCRIPTION OF ILLUSTRATED EMBODIMENT

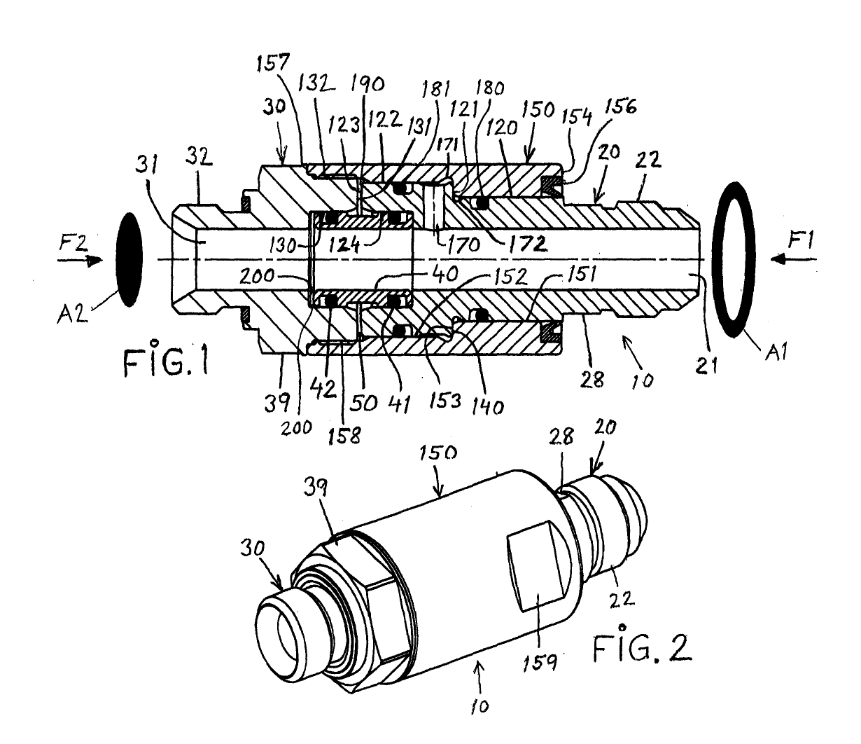

The swivel device 10 illustrated in FIGS. 1 and 2 includes a first centre part 20 and a second centre part 30 and an outer sleeve/coupling part 150 operative between the said parts 20, 30.

The first centre part 20 includes a circular centre hole 21 and has a threaded fastening portion 22 for the attachment of a first connecting hose via a coupling device. The first centre part 20 furthermore comprises a circular first step 120 passing over via a shoulder 121 into a circular second step 122 connected to an end portion 123. The step 122 comprises a circular recess 124 at its end portion 123. The first centre part 20 also comprises a key grip 28 to facilitate assembly.

The second centre part 30 includes a circular centre hole 31 and has a threaded fastening portion 32 for the attachment of a second hose via a coupling device. The second centre part 30 furthermore comprises a circular recess 130 in its end portion 131 directed away from the fastening portion 32. The second centre part 30 furthermore comprises an external threaded portion 132. The second centre part 30 furthermore has a key grip 39 to facilitate assembly.

According to the invention, a circular sleeve or a circular tube 40 is arranged in the recesses 124 and 130, as will be clear from FIG. 1. The sleeve/tube 40 bridges a gap 50 present between the end portions 123 and 131. The sleeve 40 means that the gap 50 is covered, this being very advantageous from the point of view of axial loading as the pressure medium cannot overcome pull-apart pressure of the end portions (end planes) 123 and 131. Seals 41, 42 are arranged between the sleeve 40 and the recesses 124 and 130 in order to prevent the pressure medium from reaching the gap 50. The seals 41, 42 are arranged in external grooves in the sleeve/tube 40. The sleeve 40 cooperates like a sliding bearing with circumferential portions 124 and 130 of the first and second centre parts.

The swivel device 10 furthermore includes a first axial sliding bearing 140 designed to support axial forces applied to the swivel device. The end portions 123 and 131 at the gap 50 are also designed to support axial forces in the event of certain loads and serve as a second axial sliding bearing 190.

A circular outer sleeve 150 with a nut function is designed to hold the components of the swivel device 10 together, as will be clear from FIG. 1. The outer sleeve 150 comprises two circular steps 151, 152 and a shoulder 153 arranged therebetween. The outer sleeve 150 is provided at its first end 154 with a recess for a seal 156. The outer sleeve 150 is provided at its other end 157 with an internal thread 158 cooperating with the threaded portion 132 of the second centre part 30 so as to allow for appropriate tightening. The outer sleeve 150 comprises an external key grip 159.

A radial hole 170 is arranged in the first centre part 20. The hole extends between the centre hole 21 and the circumference of the second step 122. The hole 170 is designed in such a manner that pressure medium is available to and lubricates the axial bearing 140. Seals 180 and 181 are arranged in external grooves in each step of the first centre part 20, the seals 180, 181 operating between the first centre part 20 and the outer sleeve 150. The seals 180, 181 are disposed in such a manner that the hole 170 and the axial bearing 140 are situated between the seals, as will be clear from FIG. 1.

An annular recess 171 is arranged inside the outer sleeve 150 in order to facilitate communication between the hole 170 and the axial bearing 140 for the pressure medium. An annular groove 172 is arranged on the first step 120 on the first centre part 20 at the axial bearing 140.

There is a sliding bearing function between the circumferential surfaces of the steps 120 and 122 and opposing step surfaces on the outer sleeve 150. The sleeve 40 also participates in the rotational movement.

Pressure medium loading generates an axial force Fl tending to reduce the size of the gap 50 and simultaneously increase the axial gap of the sliding bearing 140. This takes place as a result of the difference in diameter present between the steps 122 and 120. The hole 170 and the seals 180, 181 and relevant gaps ensure the intended pressure medium effect. A pressure area Al resulting in the generation of the force F1 is defined by the difference in area between the steps 122 and 120. The force F1 can as a maximum displace the first centre part 20 relative to the second centre part 30 so that the end portions 123 and 131 bear against one another, thereby eliminating the gap 50.

Pressure medium loading generates a further axial force F2 tending to increase an axial gap 200 between the second centre part 30 and the sleeve 40. The current pressure area A2 is defined by the diameter of the recess 130. The pressure area A2 gives rise to the force F2 which can as a maximum displace the first centre part 20 relative to the second centre part 30 so that the axial bearing 140 has no gap. The seals 42 ensure the intended pressure medium effect.

By varying the pressure areas A1 and A2, the axial forces F1 and F2 can be selected in such a manner that the desired resultant force is obtained. A desired mode of operation can therefore be selected for the swivel device 10 by varying the dimensions. External axial forces acting on the swivel device 10 in its operating environment may also be taken into account in this connection.

It is therefore possible to select different normal positions for the swivel device 10 by dimensioning the pressure areas A1 and A2 in such a manner that the forces F1 and F2 are of identical magnitude or in such a manner that the said forces are of different magnitude. In a preferred embodiment, F1 is selected in such a manner that it is slightly larger than F2, inter alia, taking external loading into account.

It is thus also possible to select which of the axial sliding bearings 140 and 190 will be most active.

The swivel device 10 is rotated very easily in accordance with the design concept of the invention.

All of the seals are arranged externally, this being simpler from the point of view of manufacture and assembly. According to the invention, the seals isolating the pressure areas are arranged in three different diametric planes. It will be clear that the number of seals may of course be varied as required.

The components forming part of the swivel device 10 are of course lubricated as required in connection with the assembly thereof.

It will furthermore be clear that the design of the components of the swivel device 10, such as, e.g. the fastening portions, may of course be varied considerably within the scope of this inventive concept.

The invention is not limited to what is illustrated and described here and amendments and modifications are of course possible within the scope of the accompanying claims.

1. Swivel device, in particular designed to connect two pipes or hoses rotating relative to one another, wherein the device (10) includes a first centre part (20) provided with a hole and comprising a fastening portion (22) for the attachment of a first pipe, the device (10) includes a second centre part (30) provided with a hole and comprising a fastening portion (32) for the attachment of a second pipe, the first centre part (20) and the second centre part (30) being rotatable relative to one another, characterised in that the centre parts (20, 30) are held together by means of an outer sleeve (150) anchored at one end to the second centre part (30) and at its other end arranged in a rotationally slidable manner relative to the first centre part (20), that a first axial sliding bearing (140) is arranged between the outer sleeve (150) and the first centre part (20) and that a second axial sliding bearing (190) is arranged between the first centre part (20) and the second centre part (30).

2. Swivel device according to claim 1, characterised in that the first centre part (20) is axially displaceable between a first position in which the first axial sliding bearing (140) is operative and a second position in which the second axial sliding bearing (190) is operative.

3. Swivel device according to claim 1, characterised in that a tubular part (40) is arranged inside the swivel device (10) in order to cover a gap (50) between the first centre part (20) and the second centre part (30).

4. Swivel device according to claim 3, characterised in that the gap (50) allows for limited axial movement between the first centre part (20) and the second centre part (30).

5. Swivel device according to claim 1, characterised in that the first centre part (20) comprises a through connection (170) between its centre hole (21) and its circumferential surface.

6. Swivel device according to claim 1, characterised in that a first pressure area (A1) is defined by the difference in diameter between two steps (122, 120) on the first centre part (20), and that a second pressure area (A2) is defined by the dimension of the diameter of a recess (130) in the second centre part (30).

7. Swivel device according to claim 6, characterised in that the first pressure area (A1) and the second pressure area (A2) are identical in size.

8. Swivel device according to claim 6, characterised in that the first pressure area (A1) is larger than the second pressure area (A2).

9. Swivel device according to claim 6, characterised in that the second pressure area (A2) is larger than the first pressure area (A1).

10. Swivel device according to claim 2, characterised in that a tubular part (40) is arranged inside the swivel device (10) in order to cover a gap (50) between the first centre part (20) and the second centre part (30).

11. Swivel device according to claim 10, characterised in that the gap (50) allows for limited axial movement between the first centre part (20) and the second centre part (30).

12. Swivel device according to claim 2, characterised in that the first centre part (20) comprises a through connection (170) between its centre hole (21) and its circumferential surface.

13. Swivel device according to claim 3, characterised in that the first centre part (20) comprises a through connection (170) between its centre hole (21) and its circumferential surface.

14. Swivel device according to claim 4, characterised in that the first centre part (20) comprises a through connection (170) between its centre hole (21) and its circumferential surface.

15. Swivel device according to claim 2, characterised in that a first pressure area (A1) is defined by the difference in diameter between two steps (122, 120) on the first centre part (20), and that a second pressure area (A2) is defined by the dimension of the diameter of a recess (130) in the second centre part (30).

16. Swivel device according to claim 3, characterised in that a first pressure area (A1) is defined by the difference in diameter between two steps (122, 120) on the first centre part (20), and that a second pressure area (A2) is defined by the dimension of the diameter of a recess (130) in the second centre part (30).

17. Swivel device according to claim 4, characterised in that a first pressure area (A1) is defined by the difference in diameter between two steps (122, 120) on the first centre part (20), and that a second pressure area (A2) is defined by the dimension of the diameter of a recess (130) in the second centre part (30).

18. Swivel device according to claim 5, characterised in that a first pressure area (A1) is defined by the difference in diameter between two steps (122, 120) on the first centre part (20), and that a second pressure area (A2) is defined by the dimension of the diameter of a recess (130) in the second centre part (30).

19. Swivel device according to claim 10, characterised in that the first centre part (20) comprises a through connection (170) between its centre hole (21) and its circumferential surface.

20. Swivel device according to claim 10, characterised in that a first pressure area (A1) is defined by the difference in diameter between two steps (122, 120) on the first centre part (20), and that a second pressure area (A2) is defined by the dimension of the diameter of a recess (130) in the second centre part (30).
